(19) United States
(12) Patent Application Publication
(10) Pub. No.: US 2008/0008877 A1
(43) Pub. Date: Jan. 10, 2008

(54) Catalytic Bulk Material Having Catalytically Inactive Shaped Bodies that are Rounded Off On the External Friction Surfaces

(75) Inventors: Klaus Harth, Altleiningen (DE); Thorsten Johann, Limburgerhof (DE); Christian Walsdorff, Ludwigshafen (DE); Otto Hofstadt, Speyer (DE); Michael Baier, Mannheim (DE); Wolfgang Jürgen Pöpel, Darmstadt (DE); Karin Pöpel, Darmstadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/574,973

(22) PCT Filed: Oct. 8, 2004
(86) PCT No.: PCT/EP04/11258

§ 371 Date: Apr. 7, 2006

(30) Foreign Application Priority Data
Oct. 15, 2003 (DE) 103 48 625.9

(51) Int. Cl. B01J 35/08; B01J 37/00; B32B 5/02

(52) U.S. Cl. 428/338; 502/8

(57) ABSTRACT

Novel catalyst beds comprising a physical mixture of catalytically active and catalytically inactive shaped bodies, in which the catalytically inactive shaped bodies have rounded edges on the external rubbing surfaces.

The present invention relates to novel catalyt beds comprising a physical mixture of catalytically active and catalytically inactive shaped bodies, wherein the catalytically inactive shaped bodies have rounded edges on the externally rubbing surfaces.

EP-A-60 317 discloses spherical shaped bodies comprising graphite for diluting catalyst beds in processes for the oxychlorination of ethylene to ethylene dichloride.

U.S. Pat. No. 5,202,511 discloses shaped bodies comprising aluminum oxide which may have been impregnated with an alkali metal component for diluting catalyst beds in processes for the oxychlorination of ethylene to ethylene dichloride.

EP-A-1 020 222 discloses copper in the form of sharp-edged shaped bodies such as simple hollow cylinders or trilobes as inert material for diluting catalyst beds in exothermic fixed-bed processes.

The shaped bodies comprising graphite or aluminum oxide which are used here have the disadvantage that mechanically abraded material is formed during the course of the synthesis, which leads to pressure drops.

In the case of shaped catalyst bodies which have a significantly lower mechanical strength than the shaped bodies of the diluent material, there is, in particular, the risk that the shaped catalyst bodies will be damaged by the catalytically inert shaped bodies, so that an increased pressure drop along the catalyst bed and a reduction in catalytic activity result.

It is therefore an object of the present invention to remedy the abovementioned disadvantages.

We have accordingly found novel catalyst beds comprising a physical mixture of catalytically active and catalytically inactive shaped bodies, wherein the catalytically inactive shaped bodies have rounded edges on the external rubbing surfaces.

The catalyst beds of the invention can be produced as follows:

Catalytically inactive shaped bodies which are rounded on the rubbing surfaces can be used together with catalytically active shaped bodies which are preferably rounded on the rubbing surfaces as physical mixtures in catalyst beds.

Physical mixtures are mechanically intimately mixed catalytically active and catalytically inactive shaped bodies.

The catalytically active or inactive shaped bodies which are rounded on the rubbing surfaces can be produced in suitable shaping or pressing tools, preferably tableting presses.

The mixing ratio of catalytically active shaped bodies to catalytically inactive shaped bodies can be varied within wide limits and is generally in the weight ratio range of from 0.001:1 to 10000:1, preferably from 0.1:1 to 100:1, particularly preferably from 0.5:1 to 10:1, in particular from 0.8:1 to 3:1.

Although spheres likewise have no sharp edges, they generally display a pressure drop which is too high.

For the purposes of the invention, shaped bodies are all known shaped bodies with the exception of spheres. Suitable shaped bodies are, for example, solid cylinders, doughnuts, saddles, trilobes or annular pellets, preferably solid cylinders or annular pellets, particularly preferably annular pellets.

The catalytically active or inactive shaped bodies can have edges, even sharp edges, which are not located on the rubbing surfaces, i.e. are directed into the interior of the respective shaped body. For example, annular pellets shaped according to the invention can have faces, e.g. end faces, which are rounded toward the outer rim but have sharp edges at the rim of the internal hole. However, preference is given to shaped bodies which have only rounded edges (i.e. no sharp edges at all).

The catalytically active and inactive shaped bodies can have identical, similar or different geometries. Mixtures of various geometries are also possible both for the catalytically active shaped bodies and the catalytically inactive shaped bodies. Preference is given to the catalytically inactive shaped bodies having a geometry which is the same as or similar to that of the catalytically active shaped bodies, and particular preference is given to annular pellets having rounded end faces. Very particular preference is given to annular pellets in which the end faces are rounded both toward the outer rim and toward the rim of the internal hole. Annular pellets having a doughnut-type shape are also suitable.

Such annular pellets having rounded end faces or a “doughnut” shape are known as catalysts or catalyst supports (EP-A-1 84 790, EP-A-1 052 018, U.S. Pat. No. 6,518,220).

The catalytically inactive shaped bodies and catalytically active shaped bodies used according to the invention advantageously have geometries as described in U.S. Pat. No. 6,518,220 (DE-A-100 09 017). Such shaped bodies, preferably hollow cylinders or annular pellets, have, for example, a radius of curvature of the end faces which is from 0.01 to 0.5 times, preferably from 0.05 to 0.4 times, particularly preferably from 0.1 to 0.2 times, the external diameter. The hollow cylinders or annular pellets usually have an external diameter of from 3 to 20 mm, preferably from 3 to 10 mm, particularly preferably from 3 to 7 mm, in particular from 3.5 to 6.5 mm, and an internal diameter which is from 0.1 to 0.7 times the external diameter, and a length which is from 0.2 to 2 times, preferably from 0.3 to 1.8 times, particularly preferably from 0.4 to 1.6 times, the external diameter.

For the purposes of our invention, an edge begins at an internal angle of less than or equal to 90 degrees. The shaped bodies used according to the invention preferably have an internal angle of greater than 90 degrees, in particular greater than 100 degrees.

Catalytically inactive shaped bodies are shaped bodies whose catalytic activity is from 0 to 15%, preferably from 0 to 10%, particularly preferably from 0 to 5%, in particular from 0 to 2%, of the catalytic activity of the catalytically active shaped bodies.

In particular, the catalytically inactive shaped bodies should also be as inactive as possible in respect of the catalysis of any secondary reactions, so that the overall selectivity of the process is optimized.

Suitable materials for catalytically inactive shaped bodies are (depending on the boundary conditions of the process), for example, graphite, aluminum oxide, steatite, silicon oxide or glass, preferably aluminum oxide or steatite. Aluminum oxides used are, in particular γ-, δ-, θ- or α-aluminum oxide or mixtures of these aluminum oxides. Preference is given to materials having a low BET surface area of from 0.01 to 200 m²/g, preferably from 0.1 to 150 m²/g, particularly preferably from 0.2 to 120 m²/g. Such materials can, for example, be obtained by calcination. Additives for making the material more inert can also be added to the material. For example, the shaped bodies can be impregnated with aqueous alkali metal compounds such as NaCl, KCl, preferably aqueous alkali metal compounds having a volatile anion, e.g. lithium carbonate, lithium hydrogencarbonate, sodium carbonate, sodium hydrogencarbonate, potassium carbonate, potassium hydrogencarbonate, and subsequently dried at temperatures of from 100 to 1200° C., preferably from 120 to 1000° C., particularly preferably from 150 to 700° C.

The catalytically inactive shaped bodies can be used in any heterogeneously catalyzed fixed-bed processes, preferably in exothermic gas-phase processes, in particular in processes for the oxychlorination of ethylene to ethylene dichloride, in the oxidation of hydrogen chloride to chlorine (Deacon process), in the oxidation of methanol to formaldehyde (Formox® process), in the oxidation of o-xylene or naphthalene to phthalic anhydride, in the oxidation of ethene to ethylene oxide, in the oxidation of butane, butenes, butadiene or benzene to maleic anhydride or in the oxidation of propane or propene to acrolein or acrylic acid.

Suitable catalytically active compositions for the oxychlorination of ethylene to ethylene dichloride are all catalytically active compositions known for this purpose, for example copper chloride on AL₂O₃ supports and the compositions known from WO-A-99/48606.

Suitable catalytically active compositions for the oxidation of hydrogen chloride to chlorine (Deacon process) are all catalytically active compositions known for this purpose, for example copper chloride, chromium oxide, ruthenium compounds and also the compositions known from EP-A-743 277.

Suitable catalytically active compositions for the oxidation of methanol to formaldehyde (Formox® process) are all catalytically active compositions known for this purpose, for example iron molybdate, and also the compositions known from U.S. Pat. No. 3,716,495.

Suitable catalytically active compositions for the oxidation of o-xylene or naphthalene to phthalic anhydride are all catalytically active compositions known for this purpose, for example, vanadium pentoxide or vanadium/titanium oxides, e.g. the compositions known from DE-A-2 510 994 or WO-A-00/12214.

Suitable catalytically active compositions for the oxidation of ethene to ethylene oxide are catalytically active compositions known for this purpose, for example known precious metal catalysts, e.g. the compositions known from DE 4 314 304, EP 0 557 833, EP 0 266 015.

Suitable catalytically active compositions for the oxidation of butane, butenes, butadiene or benzene to maleic anhydride are all catalytically active compositions known for this purpose, for example phosphorus/vanadium mixed oxides, e.g. the compositions known from U.S. Pat. No. 3,293,268.

Suitable catalytically active compositions for the oxidation of propane or propene to acrolein or acrylic acid are all catalytically active compositions known for this purpose, for example multimetal oxide compositions, e.g. the compositions known from EP-A-608 838, U.S. Pat. No. 3,475,488 or EP-A-575 897.

1. A catalyst bed comprising a physical mixture of catalytically active and catalytically inactive shaped bodies, wherein the catalytically inactive shaped bodies are hollow cylinders or annular pellets having rounded edges on the external rubbing surfaces, with the radius of curvature of the end faces being from 0.01 to 0.5 times the external diameter, and the catalytically active shaped bodies are not spheres.

2. A catalyst bed comprising a physical mixture of catalytically active and catalytically inactive shaped bodies according to claim 1, wherein the catalytically active shaped bodies have rounded edges on the external rubbing surfaces.

3. A method of producing catalyst beds from catalytically active and catalytically inactive shaped bodies, wherein hollow cylinders or annular pellets having rounded edges on the external rubbing surfaces, with radius of curvature of the end faces being from 0.01 to 0.5 times the external diameter, are used as catalytically inactive shaped bodies, and the catalytically active shaped bodies are not spheres.

4. The method according to claim 3, wherein the catalyst beds are used in heterogeneously catalyzed fixed-bed processes.

5. The method according to claim 3, wherein the catalyst beds are used in exothermic gas-phase processes.

6. The method according to claim 3, wherein the catalyst beds are used in processes for the oxychlorination of ethylene to ethylene dichloride, in the oxidation of hydrogen chloride to chlorine, in the oxidation of methanol to formaldehyde, in the oxidation of o-xylene or naphthalene to phthalic anhydride, the oxidation of ethene to ethylene oxide, the oxidation of butane, butenes, butadiene or benzene to maleic anhydride or the oxidation of propane or propene to acrolein or acrylic acid.
